(19) United States
(12) Patent Application Publication
(10) Pub. No.: US 2013/0173623 A1
(43) Pub. Date: Jul. 4, 2013

(54) Method for Extracting Data from a Vision

(71) Applicants: Werner Wex, Munchen (DE); Alex Baumeister, Munchen (DE)

(72) Inventors: Werner Wex, Munchen (DE); Alex Baumeister, Munchen (DE)

(21) Appl. No.: 13/806,753

(22) PCT Filed: Jun. 10, 2011
(86) PCT No.: PCT/DE2011/075131

§ 371 Date: Mar. 8, 2013

(30) Foreign Application Priority Data
Jun. 21, 2010 (DE) 1020100174785

(51) Int. Cl. G06F 17/30

(52) U.S. Cl. CPC G06F 17/30557
USPC 707/737

(57) ABSTRACT

Method for extracting data from a vision database (2) in order to form a simulation database (3), wherein in the vision database (2), graphic data of a plurality of individual objects in the form of polygons and textures assigned to the polygons are entered, and wherein in the simulation database (2) object data of the individual objects are entered, with the following steps: a) definition of object classes by classification of the individual objects described by the graphic data in the vision database (2), b) assignment of the textures to the object classes, c) generation of object data in the simulation database (3) by assignment of polygons to individual objects based on the object class assigned to the polygons via their texture.

The invention relates to a method for extracting data from a vision database in order to form a simulation database for a simulation device for simulating motion sequences in a landscape.

Known simulation devices can be used for example for training pilots or drivers of military vehicles. Such simulation devices include a graphic unit, which provides the graphic representation of the simulation based on a vision database.

In addition, such a simulation device can include one or more computer-based simulation units, which calculate the movements of objects in the landscape. The calculation of motion sequences and interactions of individual objects within the simulated landscape is performed with the aid of a simulation database, in which object data of the individual objects are entered. These object data can be the basis for the recognition of collisions and the planning of routes.

The object-based landscape can have the following individual objects by way of example: these can be objects such as buildings, such as houses and bunkers, vehicles, such as busses or tanks as well as landscape objects, such as for example plants or rocks. Further, the object-based landscape can include network objects, for example, roads, tracks and streams as well as land area objects such as fields, forests, deserts or beaches, for example.

So that a realistic simulation of the landscape and the motion sequences is possible, the vision database and the simulation database of the simulation device must correlate with one another. Thus, it is ensured that the graphic output and the behavior of the objects in the virtual landscape are consistent to one another.

Multiple standards exist for the format of the vision database, which enable the exchange of such vision databases between different graphic units. An often used type of such standards is the Open Flight Format. In a vision database, essentially the visible surfaces of the objects, so-called polygons, are entered. These polygons can be provided with attributes, which determine their colors, for example. In addition, it is possible to fill the polygon with patterns or textures. Such textures are saved in the vision database in separate graphic files and assigned to the polygons via a texture palette. In addition, the orientation of the texture placed on a polygon can be predetermined.

A hierarchical structure of the vision database, in which groups of polygons are formed, is indeed possible; however, the affiliation of polygons to individual objects in the virtual landscape is not normally reflected in the group. In addition, the polygons are grouped in the database according to their arrangement in the virtual landscape or other criteria which are important for the representation.

In contrast, no standard for the format of simulation databases exists. This is related to the distinct differences of the simulation devices. Although the visual systems of two different simulation devices are compatible to one another, still a data exchange between these simulation devices is not possible due to different formats of the simulation databases. This is problematic, in that for a new simulation device, new vision and simulation databases must be constructed.

The invention is based on the object of providing a method which enables the exchange of a vision database between two simulation devices.

The solution of this object takes place according to the present invention with the features of the characterizing part of claim 1. Advantageous embodiments of the invention are described in the dependent claims.

According to the invention, a method for extracting data from a vision database in order to form a simulation database is proposed, wherein in the vision database, graphic data of a plurality of individual objects in the form of polygons as well as textures assigned to the polygons are entered, and wherein in the simulation database, object data of the individual objects are entered, and has the following steps:

a) Definition of object classes by classification of the individual objects described in the vision database by the graphic data,

b) assignment of the textures to the object classes,

c) Generation of object data in the simulation database by assignment of polygons to individual objects based on the object class assigned with the polygons via its texture.

With this method, the exchange of a vision database between a source simulation device and a target simulation device is possible. Thus, a corresponding simulation database is formed in the target simulation device based on the graphic data in the vision database. As a result, the vision database of the source-simulation device is useable in the target-simulation device. In addition to the generation of the graphic representation in the vision system of the target simulation device, also a simulation in the target simulation device can be performed based on the generated simulation database.

The generation of the object data of the individual objects in the simulation database takes place in multiple steps. In a first step, the individual objects described by the graphic data of the vision database are classified. A list of object classes is generated.

The polygons entered in the vision database are assigned with textures, which correspond in the graphics unit to the surface of the polygon. Typically, one texture can be used for multiple polygons of the vision database. In a second step, the textures entered in the vision database are assigned to the object classes produced in the first step. Thus, a list of textures can be produced, whereby the textures are assigned to a respective determined object class. The assignment can be entered in a cross-reference list (X reference list), which can be programmed in XML for example.

In a third step, the polygons of the vision database are assigned to the individual objects of the simulation database. This assignment can be performed based on the list produced in the second step. In this connection, a compiler can be used, for example.

Preferably, the simulation database is providable to a simulation device for simulation of motion sequences in a landscape with individual objects and for simulation of interactions with these individual objects, whereby the simulation database is useable for calculating the sequence of motion and interactions in the landscape and/or whereby the vision database is useable for graphic representation of the landscape.

Preferably physical properties of the object classes are defined. The definition of physical properties of the object classes can be performed during the definition of object classes. By means of this process, additional information regarding the individual objects can be entered in the simulation database.

Advantageous is a method, in which the method steps a) and b) are performed manually and/or the method step c) is performed automatically, since in method steps a) and b), a relatively small number of elements can be processed compared to method step c). Thus, in step a), a few object classes are provided for the individual objects contained in the virtual landscape and in step b), the comparatively small number of textures of the vision database is assigned to the object class. The vision database includes fewer textures than polygons, since the textures are used repeatedly. In contrast, with the generation of object data in step c), the large number of all polygons of the vision database is to be evaluated. The automating of method step c) can substantially accelerate the method accordingly.

Preferably the assignment of a texture to an object class is provided based on a designation of the texture, in particular a filename. This offers the advantage that the graphic content of the texture must not be analyzed. Based on the designation of the texture, a quick assignment of the texture to an object class is possible.

Further, it is proposed that depending on the object class, an algorithm for generation of the object data in the vision database is selected. The object data can differ considerably, depending on the object classes. While a discrete object can comprise only a few polygons connected with one another, network objects are possible, which extend essentially over the entire landscape. Since the data structures in the simulation database can differ for the object classes, also the use of different algorithms for generating of these object data can be necessary.

Preferably, in the vision database, the graphic data are entered in the form of polygon groupings and attributes, in particular grouping designations, assigned to the polygon groupings, and the attributes are assigned to the object classes. Groupings of graphic data in the vision database can represent an object. An attribute, which is assigned to a polygon grouping, can make possible the identification of the object. Thus, a further list of attributes can be provided, which are assigned to predetermined object classes.

Particularly advantageous is the generation of object data in the simulation database by assignment of polygons of a polygon grouping to individual objects based on the object class assigned to the polygon grouping via its attributes. Analogously to the generation of object data based on the object class assigned to the polygons via their textures, the object data can be generated based on the object class assigned to the polygon grouping via its attributes. This offers the advantage that entire polygon groups can be adopted from the vision database into the simulation database.

Particularly advantageous is a method, in which all polygons of the polygon grouping are assigned to an individual object, when one polygon of a polygon grouping is assigned to this individual object. Fewer polygons must be observed because already, one polygon of a polygon grouping is sufficient in order to assign the entire polygon grouping to an individual object. In this manner, the extraction of the data from the vision database can be accelerated.

It is advantageous when object data from network objects, in particular roads, railway tracks and/or rivers are generated in the simulation database, which include network paths, whereby multiple polygons, which are assigned to a common network object class, are assigned to the network objects based on proximity relations. Thus, sections of network objects adjacent one another, for example, road sections, can be combined.

Preferably, the proximity relation includes the orientation of the texture assigned to a polygon. From the orientation of the texture assigned to a polygon, in particular the orientation of the represented object can be derived. This relates to roads, railway tracks and/or rivers in particular.

Preferably based on the coordinates of a polygon and the orientation of the assigned texture, a line piece is defined. The line piece can be oriented parallel to the orientation of the assigned texture and defines a part of the network object.

In addition, preferably adjacent line pieces of polygons of the same network object class can be combined to a network path. By the combination of adjacent line pieces of polygons to network paths, the structure of a network object can be defined.

Preferably network paths, whose end coordinates have a minimal distance form one another as a predetermined snap distance, are combined to a common network path. With this process, gaps in the network object can be recognized and closed. The snap distance must therefore be provided such that it is greater than the largest expected gap in the network object.

It is further advantageous if intersecting network paths are combined to a common network path. In this manner, multiple network paths of the same network class can be combined to a common network object.

In addition, it is proposed that a network object of the simulation database includes network nodes and that at the coordinates of an intersection of two network paths of a network object, a network node is generated. By means of the combination of two network paths in a network node to a common network path, the number of the network paths can be reduced. In this manner, the network object can be more efficiently searched for route planning, for example.

Further, it is advantageous if object data of land area objects are entered in the simulation database. By providing land area objects, in addition to discrete objects and network objects, also different properties of the land can be represented. Thus, for example, the ground that can be traveled by a vehicle can be separated from such ground which cannot be traveled by a vehicle.

Particularly advantageous for the use of the simulation database is if the simulation database has the structure of a quadtree. By means of the structure of a quad tree, the data of the simulation database can be efficiently stored for calculations in the simulation device. In addition, the structure of a quadtree accelerates access to the simulation database.

By way of the present invention, it is not necessary to revert to data additionally inserted into the vision database, since the necessary information for the simulation database can be calculated from the data contained in the visual information. Thus, only such functions for the control of the virtual individual objects can be activated, which are also supported accordingly by the vision database. By means of the invention, it further can be achieved that the simulation database is an accurate polygonal image of the vision database.

Possible embodiments of the invention are described next with reference to FIGS. 1 through 11. In the figures:

FIG. 1 shows a functional diagram of a simulation device;

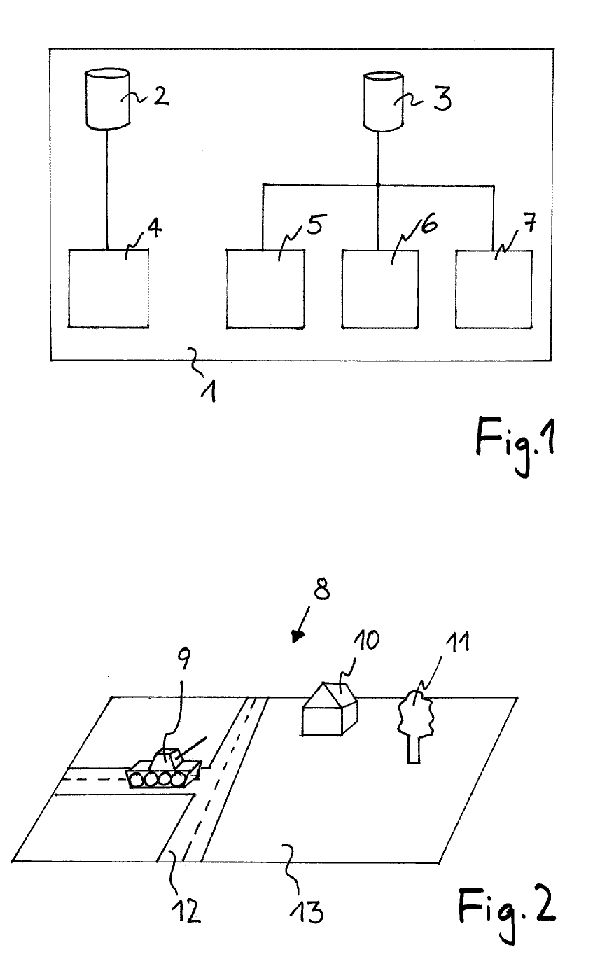

FIG. 2 shows a virtual landscape with individual objects;

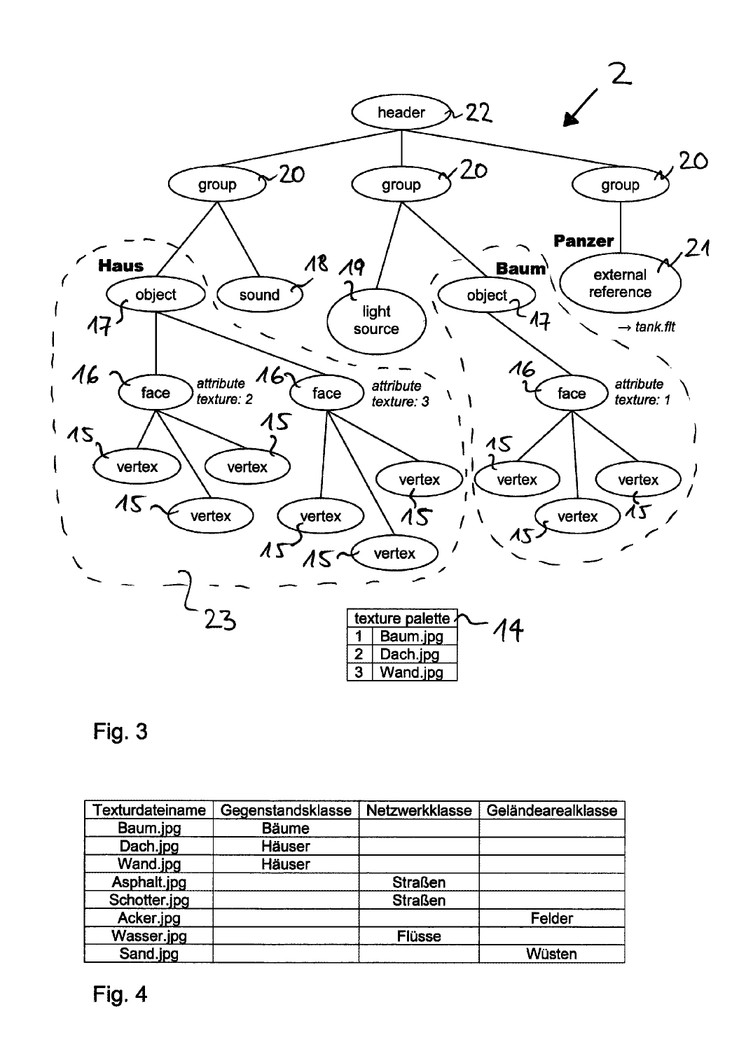

FIG. 3 shows the structure of an open-flight vision database;

FIG. 4 shows a table with an assignment of textures to object classes;

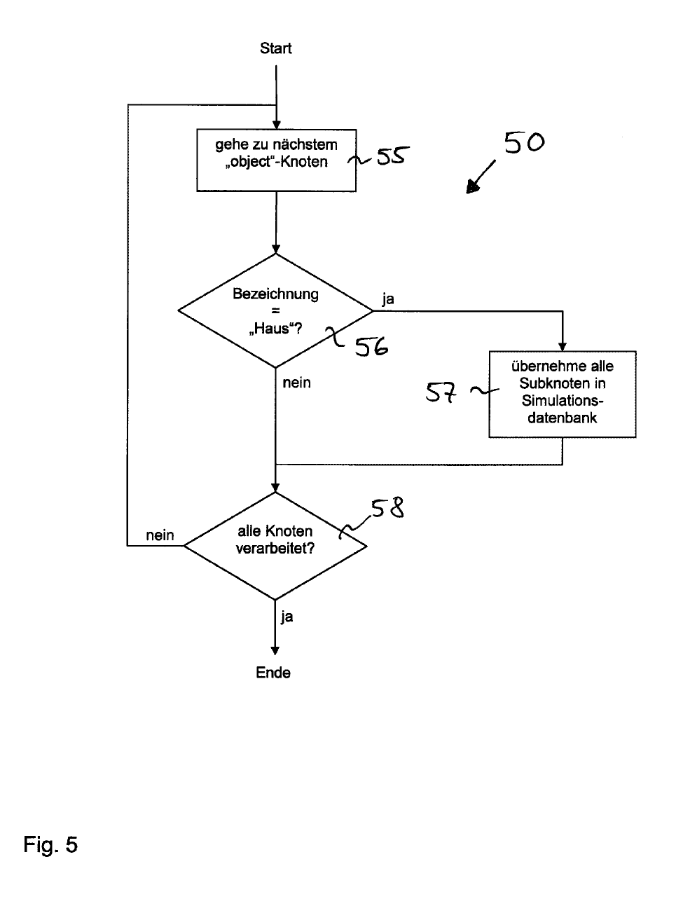

FIG. 5 shows a flow diagram of a first object recognition algorithm;

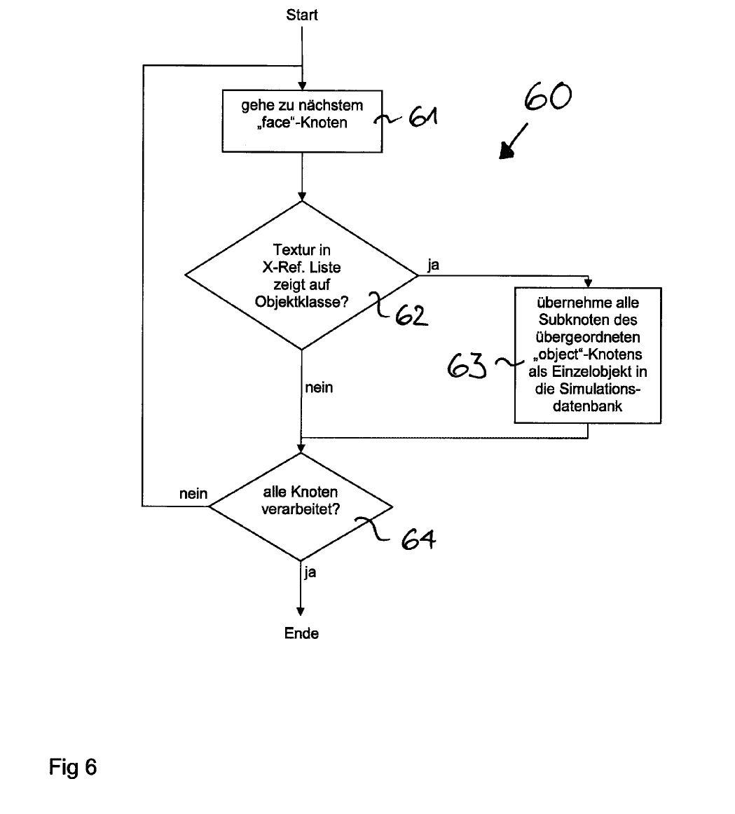

FIG. 6 shows a flow diagram of a second object recognition algorithm;

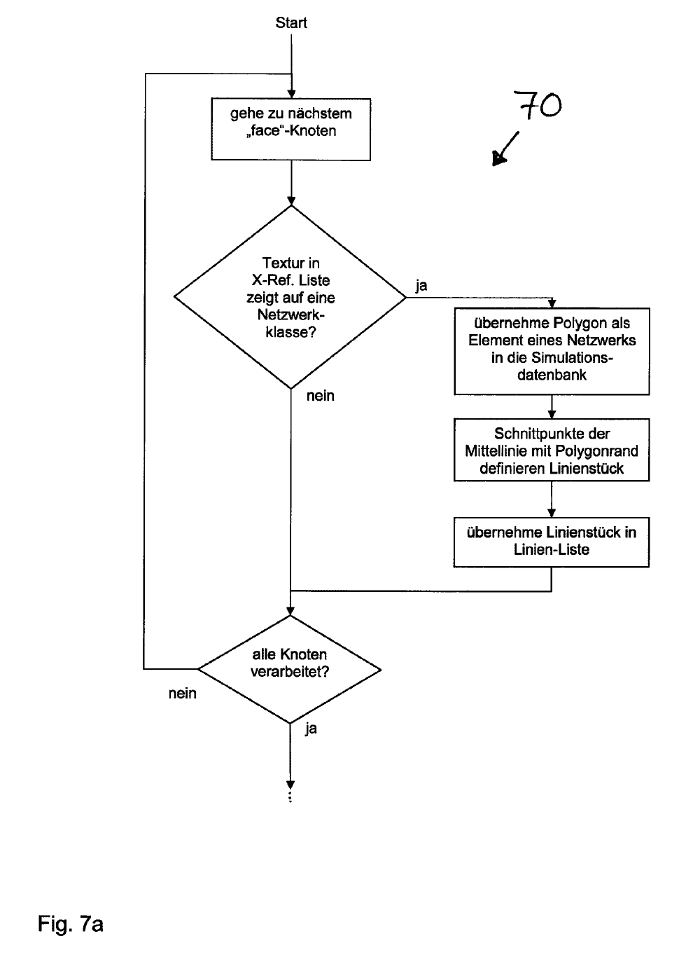

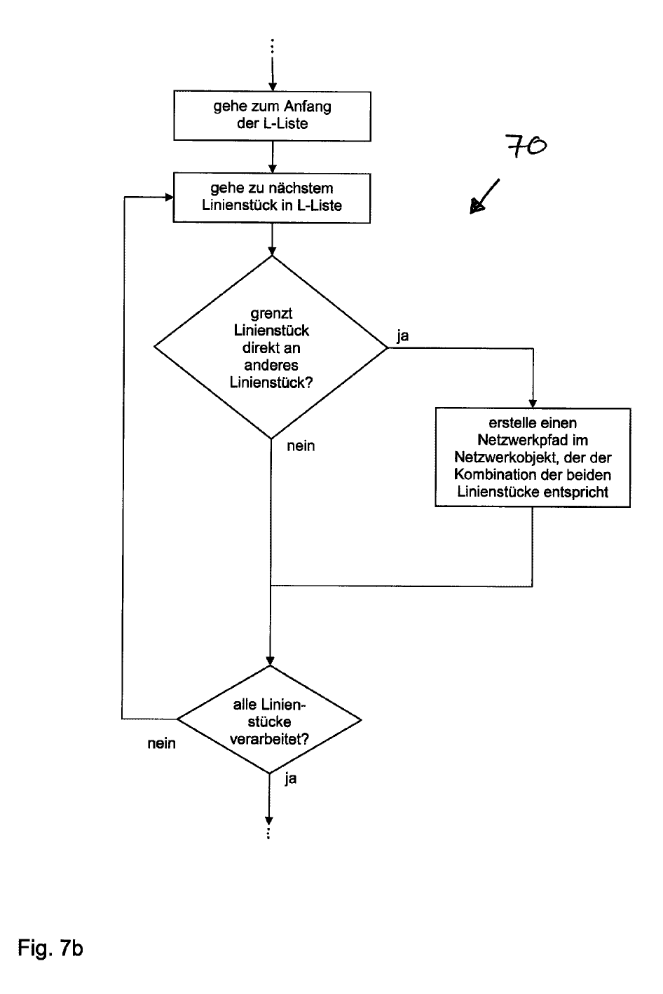

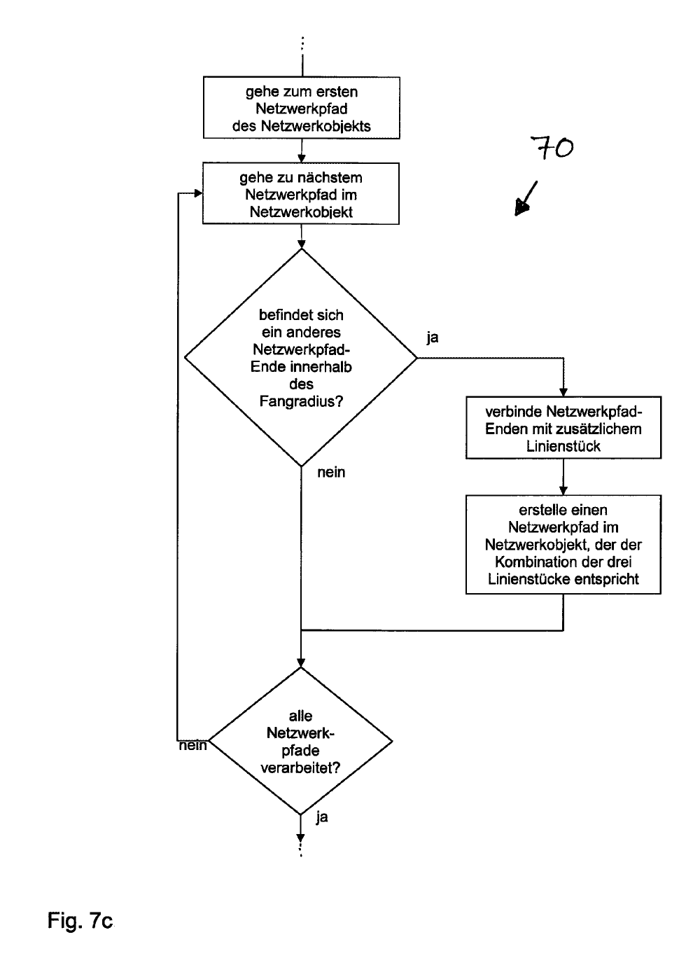

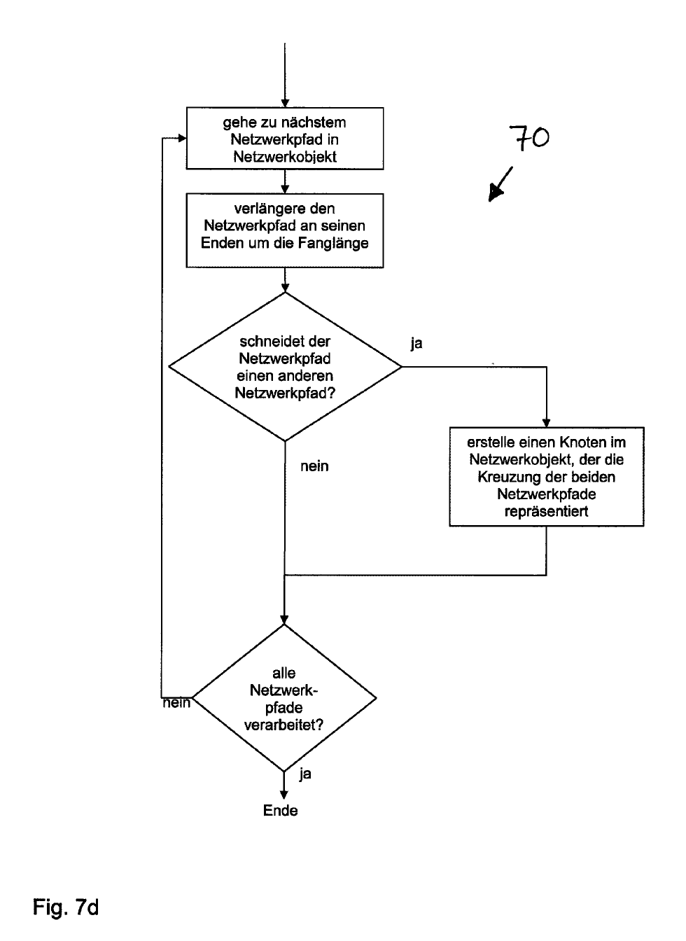

FIG. 7 shows a flow diagram of an algorithm for recognition of network objects;

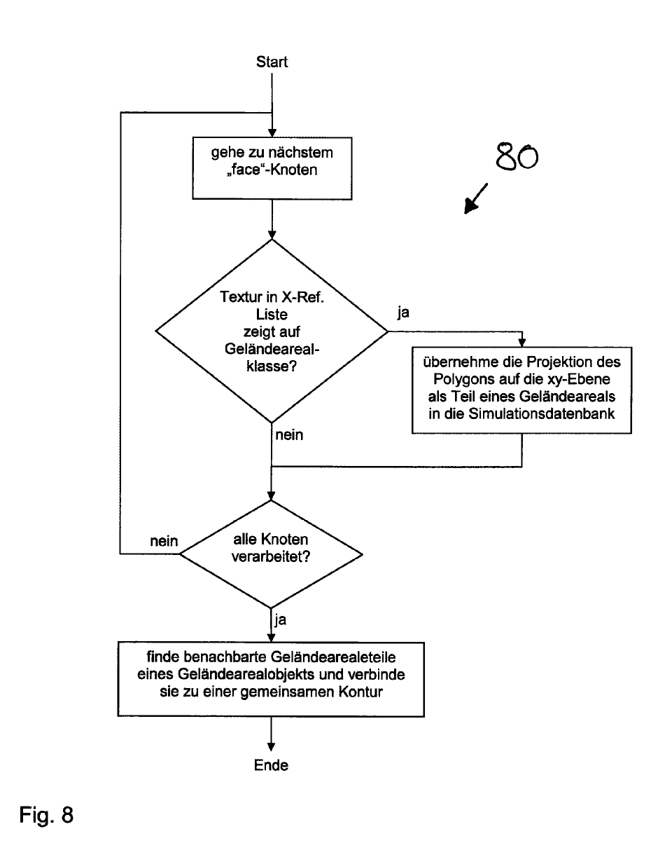

FIG. 8 shows a flow diagram of an algorithm for recognition of land area objects;

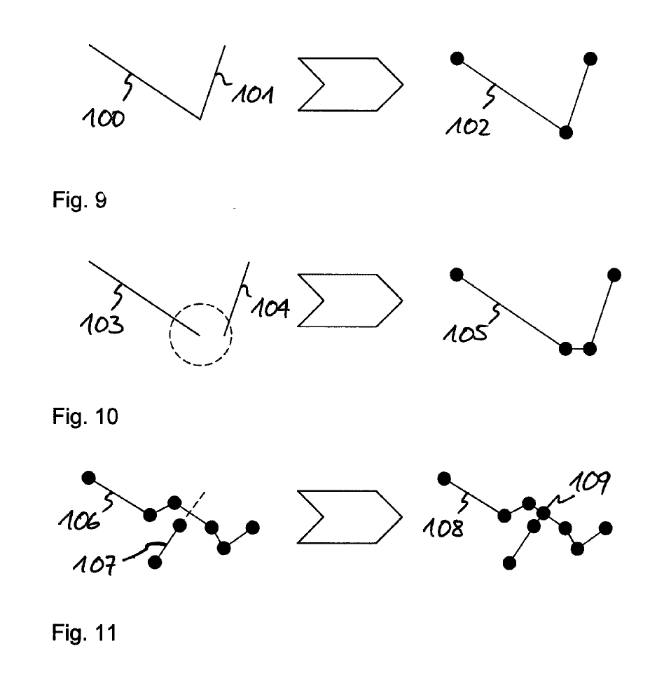

FIG. 9 shows a schematic representation of the detection of direct connections in a network object;

FIG. 10 shows the schematic representation of the detection of gaps in a network;

FIG. 11 shows the schematic representation of the detection of intersections in a network object.

The representation in FIG. 1 shows a block diagram of a simulation device, which is suited for simulation of motion sequences in a landscape 8 with individual objects 9 through 13. This simulation device 1 includes a graphic unit 4, which accesses graphic data stored in the vision database 2. In addition, the simulation device 1 includes simulation units 5 through 7, which access the object data of the individual objects 9 through 13, which are entered in a simulation database 3 programmed according to an industry standard.

The simulation database 3 represents, therefore, essentially a mathematical image of the vision database 2 and should be correlated as accurately as possible with the vision database 2, in order to make possible a “natural” navigation of computer-generated virtual forces (computer generated forces).

The simulation database 3 can be a Compact Terrain Database (CTDB), for example. The vision database 2 can be a 3D Terrain Database, for example.

The representation in FIG. 2 shows a computer-generated landscape 8 with individual objects 9 through 13. Included as individual objects 9 through 13 are discrete individual objects 9-11, network objects 12 and land area objects 13. The discrete individual objects 9-11 include, for example, vehicles 9, buildings 10, as well as landscape objects 11 such as trees. The network objects 12 include in particular roads, railway tracks, and/or rivers. The land area objects 13 include, for example, fields, deserts, and/or rocky background as part of the landscape 8.

As shown in FIG. 3, the vision database has a substantially tree-shaped structure. Starting from a root node 22, the graphic data entered into the vision database are provided as leaves of this root node 22.

A vertex node represents a point within the landscape 8 and defines the coordinates of the point within the landscape 8. A polygon, in particular a surface of the landscape 8, is entered in the vision database 2 in a face node 16. The vertex nodes 15 subordinate to the face node 16 are also recognized as its children and represent the corner coordinates of the polygon.

A polygon 16 typically is assigned with a texture. All textures used in the vision database 2 are entered in the texture palette 14. In the texture palate, references to the graphic data of the textures are provided and an ordinal number is assigned. In order to allocate a specific texture to a polygon, the texture attribute is set to the corresponding ordinal number in the face node representing the polygon.

Face nodes 16, which represent the polygons, can be grouped to objects as children of an object node 17. In addition, it is possible to carry out random groups to a group node 20 in the vision database 2. For example, an object node 17 can be grouped together with a noise node 18 and/or a light source node 19 as children of a group node 20.

In addition, references to other files of the vision database via so-called external reference nodes 21 are possible. For example, a discrete object 9-11, in particular a vehicle, can be stored in a separate file within the vision database 2.

FIG. 4 shows a so-called cross reference list. According to the present invention, in a first step, by classification of the individual objects 9-13 represented in the vision database 2 by the graphic data, object classes are defined in the cross reference list. Such object classes can be buildings, houses, trees, roads, rivers, fields, deserts, etc., for example. According to the method of the present invention, in a second step, the textures provided in the texture palette 14 of the vision database 2 are assigned to the object classes defined in the first step. This can occur in particular based on the file name, which is entered in the texture palette 14 of the vision database 2. In addition, the texture data can be visually observed and assigned corresponding to an object class.

According to the method of the present invention, in a third step, object data are generated in the simulation database 2. In this manner, the polygons of the vision database 2 automatically are assigned iteratively to the individual objects of the simulation database 3. In this regard, the algorithm 60 represented in FIG. 6 can be used. In a first step 61, a face node 16 is selected. In the following step 62, the texture attribute of the face node 16 is detected. From the texture palette 14, the assigned texture file name is determined. Further, it is checked whether this texture file name is assigned with an object class in the cross reference list. In the event the texture file name is assigned with an object class, the object node 17 superordinate to the face node is determined and all of these face nodes 16, which represent polygons, subordinate to the object node 17 are adopted as a common individual object in the simulation database 3 (step 63). Thereafter, the next face node 16 is reviewed and all face nodes 16 are processed iteratively.

A further algorithm 50 for recognition of objects within the vision database 2 is shown in FIG. 5. In contrast to the algorithm 60 shown in FIG. 6, the algorithm 59 works on object nodes 17. In a first step 55, an object node 17 is selected. In a second step 56, it is checked whether a designation is located under the attributes of the object node 17. For this purpose assignments of designations to object classes also can be entered into the cross reference list. If such a designation is recognized in step 56, in a next step 57, all nodes subordinate to the object node 17 can be adopted as individual objects in the simulation database 3. This object recognition algorithm 59 also runs iteratively and observes all provided object nodes 17 in the vision database.

In the vision database 2, multiple groupings of graphic data of the same individual object 9-13 can be contained, which represent different conditions of the individual object 9-13. Thus, for a house, for example, in an undestroyed state as well as a destroyed state can be entered in the vision database 2. Such dynamic individual objects 9-13 are entered in the vision database 2 in practice in separate files referenced by an external reference node 21 and can be recognized with an algorithm, which is based on the algorithm 50, whereby in contrast to the algorithm 50, with the algorithm for recognition of dynamic objects, external-reference nodes 21 are considered instead of object nodes 17.

Depending on the object class, different algorithms are used, in order to recognize individual objects and adopt in the simulation database 3. The presentation in FIG. 7 shows the flow chart of an algorithm for recognition of network objects 12, in particular roads, railways, and/or rivers.

Initially, it is checked for each face node of the vision database 2 whether the texture assigned to it, according to the cross reference list, is assigned to a network class. In the case that the polygon represented by the face node is assigned to a network class, then it is adopted as an element of a network object 12 in the simulation database. In addition, a line piece 100, 101 (FIG. 9) for the simulation database 3 is derived from the orientation of the texture in the vision database 2, whereby the line piece is adopted in a line list in the simulation database 3. After all face nodes 16 which represent polygons are processed, the line list is considered.

First, the line pieces 100, 101 are checked to the effect, as to whether they directly adjoin another line piece 100, 101 (see FIG. 9). If this is the case, a network path 102 is produced in the network object 12, which corresponds to the combination of both line pieces 100, 101. This method is performed for all line pieces 100, 101 in the line list.

As shown in FIG. 10, an unwanted gap can exist between two network paths 103, 104. Thus, in a further step, the network path 103, 104 of the network object are checked as to whether gaps to other network paths 103, 104 exist. Beginning from the end of each network path 103, 104, it is checked whether the end of a second network path 103, 104 lies within a predetermined distance, in particular, a snap distance. If this is the case, both network paths ends are connected with an additional line piece to form a common network path 105. Also, this algorithm for recognition of gaps is performed iteratively for all network paths 103, 104 of a network object 12.

Also, after recognition of gaps in a network object 12, still further network paths 106, 107 can be present in the network object 12. Thus, also intersecting network paths can be connected to a common network path.

Furthermore, another gap can exists between two network paths 106, 107, when the ends of the two network paths 106, 107 lie further from one another than the predetermined snap distance. In this case, as shown in FIG. 11, the network path 107 is lengthened on its end to a defined snap length. In the event this lengthening should intersect a second network path 106, a network node 109 is produced at the intersection of the two network paths, and the two network paths 106, 107 are combined into a common network path 108.

The network objects 12 represented in the vision database 2, in particular roads, are typically generated with automatic tools and can therefore include adjacent polygons, which are successive, like a corrugated sheet. After generation of the network object 12 in the simulation database 3, this corrugated sheet structure can lead to occurrence of an unwanted buckling effect in the simulation during crossing over of the network object 12. In order to prevent this, an algorithm for smoothing the network object 12 can be used in the simulation database 3.

For recognition of land area objects 13, such as lakes or closed forest areas, which can have arbitrary shapes and can contain islands, algorithm 80 shown in the flow diagram of FIG. 8 is used. All face nodes 16, which represent polygons, are checked as to whether they are assigned to a land area class. Should this be the case, the projection of this polygon on the XY-plane is formed and adopted as part of a land area object 13 in the simulation database 3. After all face nodes 16 of the vision database 2 are processed, all adjacent land area parts of a land area object 13 are connected with one another, so that they form a common contour. For example, its trafficability can be defined as a physical property of the land area.

Further, the vision database 2 can contain driving hindrance objects, which form a driving hindrance in the simulation, that is, which are impenetrable. These driving hindrance objects can be individual objects 9-13, which are recognized via the texture of their polygons according to the algorithm 60, or also point objects, which are recognized based on an attribute with the algorithm 50.

The simulation database 3 lies in the target platform in a non-illustrated manner in a quadtree and is stored as binary data sets. This provides, on the one hand, a fast loading time of the simulation database 3 and on the other hand, accelerates access. The quadtree of the simulation database comprises a static and a dynamic part. With a completely dynamic quadtree, a relatively long path exists from the outermost quadrant to the innermost. These paths can be shortened by a static grid. One can directly access the static quadrants with an index. These quadrants are subdivided then dynamically in smaller units, up to a determined maximum number of polygons.

Each quadrant contains a list of polygons, which lie completely or partially in it. Thus, polygons can be very quickly accessed online at a specific spatial position. Some applications require, however, polygons that are not nearby, rather objects. For example, a route planner wants to know which network paths and buildings are nearby. Thus, in a further processing step, important objects (buildings, trees, and network paths) are sorted in the quadtree.

### REFERENCE NUMERALS

1 Simulation device
2 Vision database
3 Simulation database
4 Graphic unit
5 Unit for route planning
6 Unit for collision recognition
7 Unit for control of individual objects
8 Landscape
9-11 Discrete individual objects
12 Network objects
13 Land area objects
14 Texture palette
15 Vertex node (corner point node)
16 Face node (polygon node)
17 Object node (object node)
18 Sound node (noise node)
19 Light source node
20 Group node
21 External reference node
22 Root node
50, 60, 70, 80 Algorithm
100, 101 Line piece
103-108 Network path
109 Network node

1-18. (canceled)

19. A method for extraction of data from a vision database (2) for forming a simulation database (3), wherein in the vision database (2), graphic data of a plurality of individual objects (9-13) in the form of polygons and textures associated with the polygons are entered, and wherein in the simulation database (3) object data of the individual objects (9-13) are entered, comprising the following steps:
a) defining object classes by classification of the individual objects (9-13) described by the graphic data in the vision database (2);
b) associating the textures to the object classes;
c) generating object data in the simulation database (3) by association of polygons to individual objects (9-13) based on the object class associated to the polygon via its texture.

20. The method according to claim 19, wherein the simulation database (3) is provided with a simulation device (1) for simulation of motion sequences in a landscape (8) with individual objects (9-13) and for simulation of interactions with these individual objects (9-13), wherein the simulation database (3) is useable for calculation of the sequence of motions and interactions in the landscape and/or wherein the vision database (2) is useable for graphic representation of the landscape (8).

21. The method according to claim 1, wherein physical properties of the object classes are defined.

22. The method according to claim 1, wherein method steps a) and b) are performed manually and/or method step c) is performed automatically.

23. The method according to claim 1, wherein the association of a texture to an object class is made based on a designation of the texture, in particular of a file name.

24. The method according to claim 1, wherein depending on the object class, an algorithm (50, 60, 70, 80) is selected for generating the object data in the simulation database (3).

25. The method according to claim 1, wherein in the vision database (2), the graphic data in the form of polygon groupings (17) and attributes, in the form of grouping designations, associated with the polygon groupings are entered and wherein the attributes are associated with the object classes.

26. The method according to claim 25, further comprising generating object data in the simulation database (3) by association of polygons of a polygon grouping (17) to individual objects (9-13) based on the object classes associated with the polygon groupings (17) via their attributes.

27. The method according to claim 25, wherein when a polygon of a polygon grouping (17) is associated to an individual object (9-13), all polygons of the polygon grouping (17) are associated with the same individual object (9-13).

28. The method according to claim 1, wherein in the simulation database (3) object data from network objects (12), which include network paths (103-108), wherein multiple polygons, which are associated with a common network object class, are associated based on the proximity relationship of the network objects (12).

29. The method according to claim 28, wherein the network objects (12) include roads, railway tracks, and/or streams.

30. The method according to claim 28, wherein the proximity relationship includes the orientation of the texture associated to the polygon.

31. The method according to claim 29, wherein based on the coordinates of a polygon and the orientation of the associated texture, a line piece (100, 101) is defined.

32. The method according to claim 31, wherein adjacent line pieces (100, 101) of polygons of the same network object class are combined to one network path (102).

33. The method according to claim 25, wherein the network paths (103, 105) whose end coordinate have a smaller distance from one another than a predetermine snap distance are combined to a common network path.

34. The method according to claim 25, wherein cut network paths (106, 107) are combined to a common network path (108).

35. The method according to claim 25, wherein a network object (12) of the simulation database (3) includes network nodes (109) and at the coordinates of cutting point of two network paths (106, 107) of a network object, a network node (109) is produced.

36. The method according to claim 1, wherein object data from land area objects are entered into the simulation database (3).

37. The method according to claim 1, wherein the simulation database (3) has the structure of a quadtree.
